(19) United States
(12) Patent Application Publication
(10) Pub. No.: US 2026/0237694 A1
(43) Pub. Date: Aug. 13, 2026

(54) FUEL CELL SYSTEM

(71) Applicant: AVL List GmbH, Graz (AT)

(72) Inventors: Raphael NEUBAUER, Graz (AT); Christoph SCHLUCKNER, Graz (AT); Krisztina KEREKES, Kecskemét (HU)

(73) Assignee: AVL List GmbH, Graz (AT)

(21) Appl. No.: 19/154,799

(22) PCT Filed: Feb. 10, 2023
(86) PCT No.: PCT/AT2023/060040

§ 371 Date: Aug. 8, 2025

(51) Int. Cl. H01M 8/04089; H01M 8/04014; H01M 8/04082; H01M 8/04701; H01M 8/12

(52) U.S. Cl. CPC H01M 8/04097; H01M 8/04022; H01M 8/04201; H01M 8/04716; H01M 8/04738; H01M 8/12; H01M 2008/1293; H01M 2250/10; H01M 2250/20

(57) ABSTRACT

Fuel cell system (1), in particular an SOFC system, comprising at least one fuel cell stack (2) with an anode section (3) and a cathode section (4), an air supply section (5), a fuel supply section (6), an exhaust gas section (7) with an afterburner (8) and a recirculation section (9), wherein a first heat exchanger (10) is arranged in the recirculation section (9), wherein a first dividing device (11a) is provided downstream of the first heat exchanger (10) to conduct a portion of the anode exhaust gas to the afterburner (8).

The invention also relates to the use of such a fuel cell system (1).

The invention relates to a fuel cell system, in particular an SOFC system, comprising at least one fuel cell stack with an anode section and a cathode section, an air supply section, a fuel supply section, an exhaust gas section with an afterburner and a recirculation section.

The invention further relates to the use of such a fuel cell system.

SOFC systems are known from the prior art. In order to distribute and also retain heat correctly in such a fuel cell system, it is known from the prior art to use a heat exchanger network. In addition, unused or unconsumed fuel in the system is typically converted in an oxidation catalyst or afterburner in order also to use this heat in the fuel cell system itself. For this purpose, it is known from the prior art to mix oxidation agents from a fuel cell stack with the unused fuel and to feed this, as such a mixture, to the oxidation catalyst. This hot exhaust gas is then passed through the heat exchanger network, which allows heat to be distributed within the system.

However, this leads to problems with fuel cell stacks which operate at high temperatures. In such a fuel cell stack, a temperature at its outlet can be 650° C. or more. This then results in very high outlet temperatures at the oxidation catalyst and even higher temperature peaks in the oxidation catalyst. This can lead to significantly increased thermal degradation of the oxidation catalyst. In addition, the unused fuel can already ignite when mixed with the hot oxidation agent from the fuel cell stack and so cause damage, for example to pipelines and also to the downstream oxidation catalyst. Furthermore, typically only a single heat exchanger is used to raise the oxidation agent from ambient conditions to the desired inlet temperature. This causes high thermal loads on this one heat exchanger and also often has the consequence that very high efficiency requirements have to be placed on this one heat exchanger. This is the starting point for the invention. The object of the invention is to provide a fuel cell system that can be operated particularly efficiently, also, in particular, at very high fuel cell stack temperatures.

Another object is to specify a use of such a fuel cell system.

According to the invention, this object is achieved in that, in a fuel cell system of the type mentioned above, a first heat exchanger is arranged in the recirculation section, a first dividing device being provided downstream of the first heat exchanger to conduct a portion of the anode exhaust gas to the afterburner.

One advantage achieved by this can be seen in particular in the fact that, by dividing the anode exhaust gas, not all of the very hot exhaust gas but only a part thereof is channelled directly to the afterburner, as a result of which a temperature in the afterburner can be lowered. This means that the temperature can also be lowered below an ignition temperature upstream of the afterburner, which avoids unwanted ignition in pipes.

At the same time, the anode exhaust gas can be cooled in the first heat exchanger, after which this enters a section which leads to the afterburner and is channelled off into the recirculation section.

The fuel cell system is in particular designed as a high-temperature fuel cell system and preferably as an SOFC system.

The recirculation section serves to recirculate anode exhaust gas as recirculation gas from the anode section of the fuel cell stack of the fuel cell system. For this purpose, the recirculation section is in particular equipped with a recirculation line which is connected to the anode section, in particular in a fluid-communicating manner. The recirculation section is integrated into the fuel cell system.

In the fuel cell system according to the invention, an air supply section is provided via which air can be conveyed from an air source in the direction of the cathode section. In the context of the invention, air is to be understood as an oxygen-containing gas. Furthermore, the fuel cell system has a fuel supply section via which fuel can be conveyed from a fuel source in the direction of the anode section. A carbonaceous gas such as methane or ethane, natural gas or also hydrogen can for example be used as fuel. In principle, a liquid fuel can also be used. Of course, other components are preferably provided in the fuel cell system, for example a reformer or a reformer heat exchanger which reforms fuel for conversion in the anode section, catalysts, for example in an exhaust gas pipeline, for converting remaining fuel components in the exhaust gas, or further heat exchanger devices.

The first heat exchanger is arranged in the recirculation section, whereby that part of the hot exhaust gas that is not channelled to the afterburner is fed to this. Consequently, a warm side of the first heat exchanger is arranged in the recirculation section, whereby a cold side of the first heat exchanger is in particular arranged in the fuel supply section, so that the first heat exchanger is in particular designed as a fuel/fuel-heat exchanger.

The afterburner is in particular designed as an oxidation catalyst to convert remaining fuel components in the exhaust gas. An exhaust gas line is provided downstream of the afterburner to release the exhaust gas into the environment. Advantageously, a third heat exchanger can be provided downstream of the afterburner to transfer heat to the air supply section.

It can also be advantageous to integrate the afterburner into a heat exchanger, e.g. into the third heat exchanger, in which case this is preferably designed as a coated heat exchanger. This is particularly advantageous if, on the one hand, the installation space is to be kept small and, on the other hand, the back pressure applied to the fuel cell stack is to be kept low. By reducing the number of components in the fuel cell system, both the installation space and also the pressure loss are reduced.

It is advantageous if a cathode discharge line and an anode discharge line are provided. That is to say, two separate sections are provided downstream of the fuel cell stack, whereby cathode exhaust gas can be carried in the cathode discharge line and anode exhaust gas in the anode discharge line. In particular, both discharge lines are routed separately from each other to the afterburner. The anode exhaust gas line leads in particular up to the first dividing device, via which a part of the anode exhaust gas in the recirculation section is passed on to the first heat exchanger and another part in the exhaust gas section is passed on to the afterburner. In principle, the anode exhaust gas line can, at least in part, be considered part of the recirculation section, whereby in particular this can at the same time be considered, at least in part, part of the exhaust gas section.

In the context of the invention, the exhaust gas section in particular comprises, at least in part, the cathode discharge line and the anode discharge line, whereby both the cathode exhaust gas and the anode exhaust gas can be conducted to the afterburner in the exhaust gas section (but preferably being conducted separately to the afterburner). Downstream of the afterburner, the exhaust gas section continues, in particular, until the exhaust gas is released into the environment. In the context of the invention, the recirculation section also includes, in particular, at least in part, the anode discharge line. The anode discharge line divides into the recirculation section and the exhaust gas section, preferably at the first dividing device.

Advantageously, a reformer heat exchanger is arranged in the fuel supply section, whereby at least a part of the cathode exhaust gas can be supplied to the reformer heat exchanger. A warm side of the reformer heat exchanger is thus arranged in the cathode discharge line. This means that the reformer is brought to operating temperature by the hot cathode exhaust gas. Downstream of the reformer heat exchanger, the cathode exhaust gas is then fed to the afterburner. The reformer heat exchanger is preferably arranged with a cold side in the fuel supply section upstream of the anode section. This thus comprises a cold side upstream of the anode section which forms a reformer and a warm side downstream of the cathode section which forms a heat exchanger. It has transpired that, weighing up different factors, it is quite possible, and can also be advantageous, to feed the cathode exhaust gas completely to the heat exchanger on the reformer or to the hot side of the reformer heat exchanger. Firstly, it is advantageous that no flow dividers are required downstream of the cathode section. It can therefore be advantageous if the cathode exhaust gas is conducted from the cathode section directly and unbranched, i.e. completely, to the heat exchanger on the reformer.

The cathode exhaust gas is thus in particular routed via the reformer, where it gives off heat to the in particular endothermic steam reforming process. The cathode exhaust gas is then mixed with the anode exhaust gas and converted in the afterburner. The anode exhaust gas is passed through the first heat exchanger beforehand to bring the anode inlet to the desired temperature.

It is expedient if a second dividing device is provided downstream of the reformer heat exchanger to divide the cathode discharge line in order to conduct part of the cathode exhaust gas directly and part of the cathode exhaust gas indirectly to the afterburner. This means that not all of the cathode exhaust gas is conducted to the afterburner via the reformer heat exchanger; rather, some of it is also conducted directly to the afterburner. Also advantageously, a second connection is provided upstream of the afterburner at which the previously divided cathode exhaust gas reunites and is conducted together to the afterburner. This makes the temperature in the afterburner even more readily controllable, since heat is extracted from both the anode exhaust gas and the cathode exhaust gas via a suitable heat exchanger network before these gases are fed into the afterburner. The temperature at the mixing point is lowered through the transfer of heat from both the cathode exhaust gas and the anode exhaust gas upstream of the afterburner. In addition, this also reduces the temperature in and after the afterburner, which prevents increased thermal degradation of the afterburner. This design also brings the advantage that the temperature on the reformer can be actively controlled by reducing the mass flow via the reformer. This means that the design of the heat transfer in the reformer is no longer so critical.

It is advantageous if a cold side of the first heat exchanger is arranged downstream of the reformer heat exchanger and a warm side of the first heat exchanger is arranged in the anode discharge line. The reformed fuel can thus be fed, downstream of the reformer heat exchanger, to the first heat exchanger, through which it can be brought to a predetermined temperature by the hot anode exhaust gas for use in the anode section. The first heat exchanger is therefore designed as a fuel/fuel heat exchanger. It is advantageous if a second heat exchanger is provided in the recirculation section, wherein a warm side of the second heat exchanger is arranged downstream of the first dividing device. In the second heat exchanger, the anode exhaust gas in the recirculation section can be cooled further.

It is also advantageous if a fan is arranged in the fuel supply section or in the recirculation section to ensure that the anode gas is conveyed or recirculated. The fan is in particular designed as a recirculation fan and can for example be arranged downstream of the cold side of the second heat exchanger. Alternatively, the fan can also be arranged in the fuel supply section, which is connected to the recirculation section. The arrangement of the second heat exchanger has the advantage that the thermal load in the fan and also the compression work thereof can be reduced.

It is expedient if the fuel supply section includes a fuel line, whereby the fuel line is connected to the recirculation section upstream of a cold side of the second heat exchanger. Fresh fuel is thus introduced into the recirculation section via a first fluidic connection between the fuel supply section and the recirculation section. It can be advantageous if the fresh fuel in the fuel line can be sucked in via the fan if the supply pressure is too low. For this purpose, a control unit can for example be built into the fuel line in order also to be able to regulate the fuel supply independently of the recirculation rate. If the supply pressure of the fresh fuel is high (e.g. over 300 mbar), the fresh fuel can only be fed into the recirculation section after the fan. The fuel supply section, now enriched with fresh fuel, is preheated in the second heat exchanger and introduced into the reformer and reformed (with heat input from the cathode exhaust gas, as described above). The fuel is then brought to the required anode inlet temperature in the first heat exchanger (heat from the anode exhaust gas, as described above).

Advantageously, a starter burner is provided. The starter burner heats up the fuel cell system. The starter burner can for example advantageously be designed as a flame burner, as a catalytic burner or as a hybrid burner (catalytic combined with flame). It can also be advantageous if the starter burner is integrated into or combined with an oxidation catalyst. The heat released by the starter burner can advantageously be introduced into the system at various points, for example into a cathode exhaust gas line directly downstream of the cathode section, into the air supply section or directly into the oxidation catalyst or downstream or upstream thereof. The arrangement of the starter burner depends on individual component specifications such as temperature limits, compatibility of combustion exhaust gas and the like. In the heating-up process of the fuel cell system, heat is generated in the starter burner, whereby a line for supplying fuel and air to the starter burner is provided.

For example, a cathode inlet temperature at the fuel cell stack can be controlled with the division of the cathode exhaust gas described above, since this influences a reformer outlet temperature at the same time. However, the cathode inlet temperature can also be controlled via the starter burner, whereby air and/or fuel is supplied to the start burner.

A fuel cell system according to the invention is advantageously used as a stationary system or in a motor vehicle. Advantageously, the fuel cell system according to the invention can also be used in marine applications or in aircraft.

Further advantages, features and details of the invention are explained in the following description, in which exemplary embodiments of the invention are described in detail with reference to the drawing. In each case schematically:

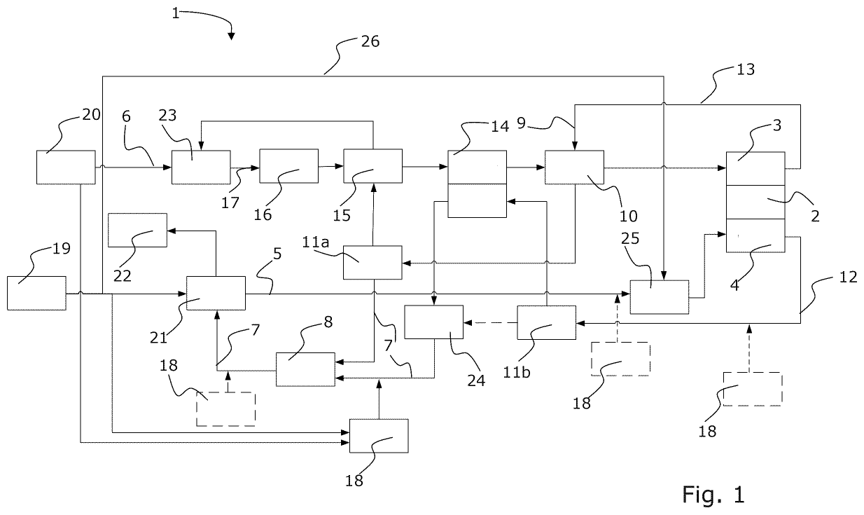

FIG. 1 shows a schematic representation of a fuel cell system according to the invention;

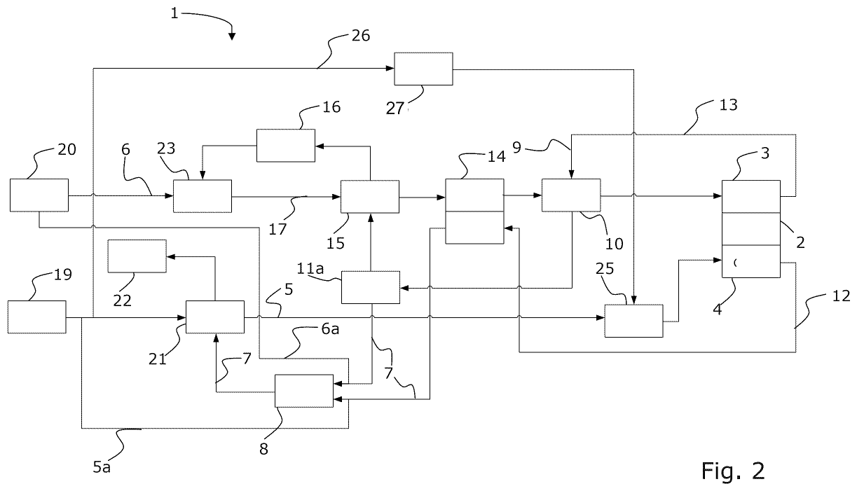

FIG. 2 shows a schematic representation of another fuel cell system according to the invention;

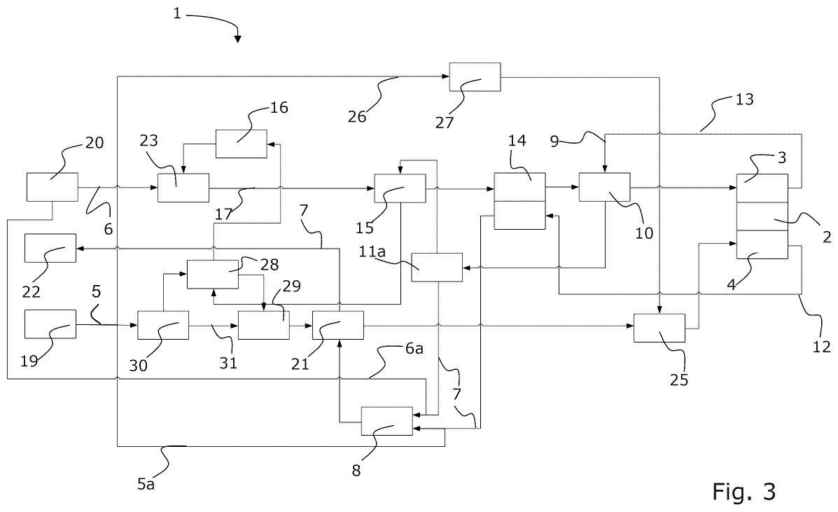

FIG. 3 shows a schematic representation of another fuel cell system according to the invention.

FIG. 1 shows a fuel cell system 1 according to the invention with a fuel cell stack 2 comprising an anode section 3 and a cathode section 4. An air source 19 is provided to which an air supply section 5 is connected to convey air in the direction of the cathode section 4. A fuel source 20 is also provided which is connected to a fuel supply section 6 with a fuel line 17 to convey fuel in the direction of the anode section 3. The fuel cell system 1 also includes a recirculation section 9, through which exhaust gas from the anode section 3 is pumped back towards the anode section 3 by a fan 16. An exhaust gas section 7 with an afterburner 8 is provided. The afterburner is designed as an oxidation catalyst, whereby both a cathode discharge line 12 and an anode discharge line 13 lead into this, at least indirectly. Anode exhaust gas is thus burned with cathode exhaust gas being supplied. The burned exhaust gas is then discharged into the environment 22 via a third heat exchanger 21.

The anode discharge line 13 and the cathode discharge line 12 are designed as two separate lines. In the fuel cell system 1 according to FIG. 1, these lines of the exhaust gas section 7 are routed separately to the afterburner.

The anode discharge line 13 is routed downstream of the anode section 3 in the recirculation section 9 and leads into a first heat exchanger 10 arranged downstream of the anode section 9, through which the warm anode exhaust gas transfers heat to the fuel in the fuel line 17. The first heat exchanger 10 is thus designed as a fuel/fuel heat exchanger. A first dividing device 11a is arranged downstream of a warm side of the first heat exchanger 10, through which the anode exhaust gas can be divided in such a way that a part thereof is conducted further in the recirculation section 9 and another part thereof is conducted in the direction of the afterburner 8. The exhaust gas section 7 continues to the afterburner 8.

The exhaust gas which is conducted onwards in the recirculation section 9 passes through a second heat exchanger 15 which is arranged with a cold side in the fuel supply section, and is fed into the fuel supply section 6 downstream of the second heat exchanger via a first connection 23.

According to FIG. 1, the fan 16, which is designed as a recirculation fan, is arranged in the fuel supply section 6 between the first connection 23 and the cold sides of the second heat exchanger 15. With this arrangement of the fan 16, it is possible to reduce the thermal load of the fan 16 and also the compression work. In addition, with a corresponding design, the fresh fuel can be sucked in via the fan 16 if the supply pressure is too low. For this purpose, a control unit can also be installed in the fuel supply section 6 (not shown) in order to be able to control the fuel supply independently of a recirculation rate.

Upstream of the fan 16, a first fluidic connection 23 is provided between the recirculation section 9 and the fuel supply section 6, so that the recirculation section 9 and the fuel supply section 6 are merged. The fresh fuel is now conveyed together with the recirculated exhaust gas in the direction of the anode section 3. In a first step, this fuel is now passed through the cold side of the second heat exchanger 15, which heats it up again.

Arranged upstream of the anode section 3 and downstream of the cold side of the second heat exchanger 15 is the reformer heat exchanger 14, which prepares the fuel for use in the anode section 3. Cathode exhaust gas is fed to the reformer heat exchanger 14 via the cathode discharge line 12 to heat up the corresponding reformer section. According to FIG. 1, in a first version (solid line), all of the cathode exhaust gas can be supplied to the warm side of the reformer heat exchanger 14, being fed to the afterburner 8 downstream of the reformer heat exchanger 14. In a second version (dashed line), a second dividing device 11b is provided to divide the cathode discharge line 12 in order to conduct a portion of the cathode exhaust gas to the afterburner 8, i.e. not all the cathode exhaust gas is fed to the afterburner 8 via the reformer heat exchanger 14; rather, part of it is fed directly to the afterburner 8. In this version, a second connection 24 is provided to reunite the two partial streams of the cathode exhaust gas upstream of the afterburner 8.

In the air supply section 5, air is conducted from the air source 19 in the direction of the cathode section 4, whereby this is fed through the cold side of the third heat exchanger 21 upstream of the air source 19 and thus heated. Downstream of the third heat exchanger 21 and the cathode section 4, a third connection 25 is provided in which the heated air can if necessary be mixed with fresh air which is introduced via an additional air line 26 in order to regulate an inlet temperature of the cathode section, also in particular without delay.

The fuel cell system 1 according to FIG. 1 further comprises a starter burner 18, to which both fuel from the fuel source 20 and air from the air source 19 are supplied. The starter burner 18 is arranged and designed to heat up the fuel cell system 1. For this purpose, the heat is for example supplied upstream of the afterburner 8 (solid line) or downstream of the afterburner (dashed line) or the air supply section 5 (dashed line) or the cathode exhaust line 12 (dashed lines). Furthermore, the temperature of the cold outlet side of the third heat exchanger 21 can be lowered or increased and thus regulated during operation through the supply of air and/or fuel. In addition, the supply of air and/or fuel makes it possible to regulate a temperature in the afterburner 8 in such a way that it is protected from overheating.

FIG. 2 shows another fuel cell system 1 according to the invention. Elements which have the same function and in particular the same arrangement as those according to FIG. 1 also have the same reference signs and are not described further. In contrast to FIG. 1, in the fuel cell system 1 according to FIG. 2 the fan 16 is arranged downstream of the warm side of the second heat exchanger 15 and upstream of the first connection 23. This design is advantageous if a supply pressure of the fresh fuel should be high (e.g. more than 300 mbar). In this case the fresh fuel is only connected to the recirculation section 9 via the first connection 23 after the fan 16.

In addition, in the fuel cell system 1 according to FIG. 2, a separate air line 5a and a separate fuel line 6a are provided through which air and fuel can be brought to the afterburner 8. This makes it even easier to control the temperature and ignitability in the afterburner. Furthermore, the temperature of the cold outlet side of the third heat exchanger 21 can be lowered or increased and thus regulated during operation through the supply of air and/or fuel.

The third connection 25 is again provided, in which the heated air can if necessary be mixed with fresh air which is introduced via the additional air line 26. In this version of the fuel cell system 1, a heater 27, in particular an electric heater 27, is also provided, as a result which the additional air line 26 can also be used for a heating-up process. For simplicity, the starter burner 18 is not shown in FIG. 2. In the fuel cell system 1 according to FIG. 2, the second connection 24 is not shown. However, this fuel cell system 1 may also have the version with the second connection 24 according to FIG. 1.

FIG. 3 shows another fuel cell system 1 according to the invention. Here, too, elements which have the same function and in particular the same arrangement as those according to FIG. 1 or 2 also have the same reference signs and are not described further. In contrast to the fuel cell systems 1 according to FIGS. 1 and 2, in this case a heat exchanger network with a fourth heat exchanger 28, a fourth connection 29 and a third dividing device 30 is provided in the air supply section 5.

The air supply section 5 has a bypass line 31 by means of which the fourth heat exchanger 28 can be bypassed. For this purpose, the third dividing device 30, from which the bypass line 31 branches off, is provided upstream of the fourth heat exchanger 28, and the connection 29, at which the bypass line 31 reconnects, is provided upstream of the third heat exchanger 21.

The fourth heat exchanger 28 is provided upstream of the connection 29, the cold side thereof being arranged in the air supply section 5 and its warm side in the recirculation section 9 upstream of the fan 16, so that an inlet temperature of the fan can be efficiently controlled. The fourth heat exchanger 28 is thus designed and arranged as a fuel/air heat exchanger.

For simplicity, the starter burner 18 is not shown in FIG. 3. In the fuel cell system 1 as shown in FIG. 3, the second connection 24 is not shown. However, this fuel cell system 1 may also have the version with the second connection 24 according to FIG. 1.

1. Fuel cell system (1), in particular an SOFC system, comprising at least one fuel cell stack (2) with an anode section (3) and a cathode section (4), an air supply section (5), a fuel supply section (6), an exhaust gas section (7) with an afterburner (8) and a recirculation section (9), wherein a first heat exchanger (10) is arranged in the recirculation section (9), wherein a first dividing device (11a) is provided downstream of the first heat exchanger (10) to conduct a portion of the anode exhaust gas to the afterburner (8).

2. Fuel cell system (1) according to claim 1, wherein a cathode discharge line (12) and an anode discharge line (13) is provided.

3. Fuel cell system (1) according to claim 1, wherein a reformer heat exchanger (14) is arranged in the fuel supply section (6), wherein at least part of the cathode exhaust gas can be supplied to the reformer heat exchanger (14).

4. Fuel cell system (1) according to claim 2, wherein a second dividing device (11b) for dividing the cathode discharge line (12) is provided downstream of the cathode section (4) to conduct a portion of the cathode exhaust gas directly and part of the cathode exhaust gas indirectly to the afterburner (8).

5. Fuel cell system (1) according to claim 2, wherein a cold side of the first heat exchanger (10) is arranged downstream of the reformer heat exchanger (14) and a warm side of the first heat exchanger (10) is arranged in the anode discharge line (13).

6. Fuel cell system (1) according to claim 1, wherein a second heat exchanger (15) is provided in the recirculation section (9), wherein a warm side of the second heat exchanger (15) is arranged downstream of the first dividing device (11a).

7. Fuel cell system (1) according to claim 1, wherein fan (16) is arranged in the fuel supply section (6) or in the recirculation section (9).

8. Fuel cell system (1) according to claim 1, wherein the fuel supply section (6) comprises a fuel line (17), wherein the fuel line (17) is connected to the recirculation section (9) upstream of a cold side of the second heat exchanger (15).

9. Fuel cell system (1) according to claim 1, wherein starter burner (18) is provided.

10. (canceled)

11. A stationary installation with a fuel cell system according to claim 1.

12. A motor vehicle with a fuel cell system according to claim 1.
